(19) United States
(12) Patent Application Publication
(10) Pub. No.: US 2010/0046789 A1
(43) Pub. Date: Feb. 25, 2010

(54) METHOD FOR CONVERTING ELECTRIC SIGNALS INTO ACOUSTIC OSCILLATIONS AND AN ELECTRIC GAS-KINETIC TRANSDUCER

(76) Inventors: Sergey Vladimirovich Shishov, Moskovskaya obl. (RU); Sergey Alexandrovich Andrianov, Moskovskaya obl. (RU); Sergey Pavlovich Dmitriev, St. Petersburg (RU); Dmitriy Victorovich Ruchkin, Moskovskaya obl. (RU)

Correspondence Address: COLLARD & ROE, P.C., 1077 NORTHERN BOULEVARD, ROSLYN, NY, 11576, US

(21) Appl. No.: 12/312,412

(22) PCT Filed: Nov. 10, 2006
(86) PCT No.: PCT/RU2006/000589

§ 371 Date: Jun. 16, 2009

(51) Int. Cl. H04R 11/02

(52) U.S. Cl. 381/423

(57) ABSTRACT

The invention relates to electroacoustic engineering, in particular to methods for converting electric signals into acoustic oscillations and to electroacoustic transducers. The method for converting electric signals into acoustic oscillations comprises exposing an oscillating system that is a gas medium pre-structured by a static electric field to an electric/electromagnetic field modulated in strength by an alternating electric signal in accordance with the shape and frequency of the modulating signal, and converting the energy of the field into acoustic energy to be released thereupon into the ambient. An electric gas-kinetic transducer developed to perform this method comprises a dielectric working element and at least two current-conducting plates that can be connected to the pole terminals of a direct voltage source and to a source of alternating electric signals. The operating principle of the transducer consists in converting the energy of the electric/electromagnetic field into the kinetic energy of gas, and then the kinetic energy of gas into acoustic radiation. This work is performed by gas filling nano/micro-sized channels of the capillary pore matrix of the working element under the effect of the external electric/electromagnetic field. An electric signal is converted into acoustic oscillations without involving mechanical intermediary devices, making it possible to avoid amplitude-phase and amplitude-frequency distortions and to reach a matching between the properties of the oscillating system, or a pre-structured gas medium, and the properties of the transmitting medium, or air, thereby improving the efficiency of conversion.

The invention relates to electroacoustic engineering, in particular to methods for converting electric signals into acoustic oscillations and to electroacoustic transducers. The invention makes it possible to convert electric signals into acoustic oscillations and can be used in acoustic devices such as loudspeakers for reproducing music and voice, and also in various specialized devices for fulfilling applied functions.

Mechanical intermediary devices of various types are used in all prior art methods for converting electric signals into acoustic oscillations and in practical designs of loudspeakers carrying out these methods.

Electrodynamic Conversion Method. A large number of electrodynamic systems is used in prior art in which a piston in the form of a resonant horn of various forms and designs is used as the mechanical intermediary device. For example, a flat acoustic transducer is disclosed in Patent PCT/JP 98/02503 of Jun. 5, 1998, Patent PCT/WO 99/03304 of Jan. 21, 1999, and Patent RU No. 2179788 of Feb. 16, 2002, in which electric signals are converted into sound signals by a movable vibrating membrane.

Electrostatic Conversion Method. An electrostatic loudspeaker is disclosed in Patent RU No. 2010459 of Mar. 3, 1994. A membrane placed in the air spacing between two fixed perforated electrodes functions as a mechanical intermediary device in this invention. As polarizing voltage is applied to the membrane symmetrically relative to the electrodes and as sound voltage is connected asymmetrically to the electrodes, the membrane begins to vibrate under the effect of the difference between the forces of attraction to the electrodes in time with audio-frequency oscillations.

Electrostatic Martin Logan speakers known in the art comprise three principal elements—two stators, a diaphragm of a thin transparent material functioning as a mechanical intermediary device, and the so-called spacers. The spacers restrict the freedom of movement of the diaphragm between the stators.

Electromagnetic Conversion Method. Prior art Magneplanar planar acoustic systems were developed by Magnepan company on the basis of strip and quasi-strip transmitters in which the intermediary device is a very thin strip of corrugated metal foil, or metal foil glued to a Dacron diaphragm that vibrates in accordance with the shape of current flowing therein in the field of powerful permanent magnets made in the form of rods extending parallel to the strip.

A prior art electroacoustic transducer disclosed in Patent RU No. 2071186 of Apr. 16, 1997,has a mechanical intermediary device in the form of a stack comprising a set of alternating flat conducting and dielectric layers produced by sputtering on one another. The stack is placed in a strong alternating magnetic field and the leads of the stack plates are connected to a direct current generator. Ampere's alternating force is applied periodically to the plates to compress or extend the low-elasticity dielectric substrate between the conducting plates. Since, however, one side of the stack is fixed firmly in place, the other side vibrates at the frequency of the magnetic field generator because of change in the total volume of the stack. The volume change causes acoustic waves.

Electrostrictive Conversion Method. A prior art electrostrictive speaker model comprises a mechanical intermediary device that is made of a soft silicon polymer placed between two layers of a flexible current-conducting material that changes its shape under the effect of an electric field.

Another device for generating acoustic oscillations and mechanical vibrations disclosed in Patent RU No. 2184622 of Jun. 10, 2002 is an electrostrictive transducer using an amorphous dielectric material having a dipole structure as a mechanical intermediary device placed between current-conducting plates.

Piezoelectric Conversion Method. Several transducer types use piezoelectric materials as a mechanical intermediary device. A change in the voltage applied causes the degree of deformation of the piezoelectric material to change accordingly so that acoustic waves are generated.

Method Using Aerodynamic Conversion of Electric Audio Frequency Signals. A device using this method causes a transparent panel to vibrate under the pressure of air generated by a transducer placed in the space behind the panel. This technique allows air pressure to be transmitted across the entire panel surface that actually serves as a mechanical intermediary device generating acoustic oscillations.

Distributed Vibration Method. Prior art acoustic NXT panels are excited by one or several special-purpose transducers fixed at certain points on the panel. In this instance, the panel material itself serves as a mechanical intermediary device in which complex vibration processes are caused to occur.

For all the differences in design and methods for generating acoustic oscillations, all the foregoing acoustic systems have a common drawback. They introduce amplitude-phase and amplitude-frequency distortions because of their mechanical vibratory system that is made of materials having properties distinct from the properties of the conducting medium (air) and have actually reached the limit of efficiency in converting an electric signal into acoustic oscillations by causing a mechanical intermediary device to move.

In an optimal situation, had 100% of the energy of the mechanical intermediary device been transmitted to the ambient air, significant losses and distortions of the signal applied would have occurred. Moreover, losses and distortions occur at all conversion stages as well. For example, conversion of an electric signal into an acoustic signal in electrodynamic loudspeakers has at least four stages. Electric signal energy is converted into magnetic energy that is then converted into the kinetic energy of the loudspeaker horn. The horn, in its turn, generates sound waves in the air. The sound waves carry the acoustic energy of sound oscillations that are heard by the human ear. An obvious solution eliminating undesired effects is one in which electric energy is converted directly into acoustic energy without the use of mechanical intermediary devices and intermediary stages.

Ion plasma transmitters, with attempts to develop them made as early as the 1930s, are an example of this approach. They produce a sort of plasma in the air, its geometric characteristics changing with audio frequency. The varying plasma volume generates lengthwise pulses in the air, that is, it fulfills the same function as the resonant horn of a conventional loudspeaker or another mechanical intermediary device. A disadvantage of such transducers is gradual pulverization of the electrode material and its deposition on the discharge tube walls, limiting the service life of the tube because of increasing noise.

It is an object of this invention to achieve a matching of the properties of the oscillating system and the conducting medium, that is, to cause the air itself to sound, avoiding its conversion into plasma, and also doing without a mechanical intermediary device and intermediary electric signal conversion stages. Accordingly, limitations inherent in ion plasma transmitters and mechanical oscillating systems are removed. Solution of this problem helps develop an industrial technology for manufacturing acoustic systems that are widely used for home and commercial purposes and have new sound qualities and allow unusual sound effects to be produced. Limitations are only imposed by the electronic part of the system (the recording and playback channel as a whole, from microphone and sound recording equipment to amplifier converting the signal transmitted) and the developer's imagination.

The technical result that can be produced by exercising the invention consists in that the properties of the oscillating system are matched with those of the transmitting medium, and that the efficiency of electric signal conversion into acoustic oscillations is improved.

The use of this invention in acoustic systems will help produce new sound quality characteristics and offer the possibility of producing a holographic sound picture.

This technical result is achieved in a method for converting electric signals into acoustic oscillations by exposing an oscillating system that is a pre-structured gas medium by an electric/electromagnetic field modulated by an alternating electric signal for exciting it, in accordance with the shape and frequency of the electric signal applied, and converting the energy of this field into acoustic energy that is released thereafter into the ambient.

This method uses electrokinetic conversion of an electric signal into a nonelectric effect by applying an electric/electromagnetic field modulated by an alternating electric signal to an oscillating system that is a pre-structured gas medium. As a result, the gas medium is oscillated acoustically in accordance with the shape and frequency of the signal applied.

A multi-functional electric gas-kinetic transducer developed for performing this method comprises a dielectric working element and at least two current-conducting plates that can be connected to the pole terminals of a direct current source and a source of alternating electric signals, said plates comprising one layer or multiple layers of macro-, and/or micro-, and/or nano-level dimensions having different topologies and relative spatial locations, at least one of the plates being optionally gas-permeable and/or designed as an electrode system, or matrix element; the dielectric working element being a single- or multi-layered gas-permeable channeled matrix system of macro-, and/or micro-, and/or nano-level dimensions having a developed network of nano/micro channels containing a gas-permeable medium, the layers of which may be separated by a dielectric gas-impermeable layer at any point and have a different spatial location relative to the current-conducting plates/electrode systems.

For operation in specific conditions, the transducer may be placed in a tightly sealed housing 12. The working element of the transducer may be placed between or on the current-conducting plates that are formed as separated electrode regions adapted to be connected to the pole terminals of a direct current source and a source of alternating electric signals. In the first instance, the working element may consist of at least two layers separated by a dielectric gas-impermeable layer. In the second instance, the working element is covered by an additional current-conducting plate overlapping the area of the electrode regions and cannot be connected to the pole terminals of the direct current source and the source of alternating electric signals.

The transducer may comprise multiple layers and be designed as a stack of alternating current-conducting plates and working elements, at least one of the current-conducting plates being optionally supplied with an additional alternating electric signal from a separate source.

The transducer of this invention helps: achieve a high rate of front increase and decline of the signal reproduced and a very wide dynamic range; produce a uniform acoustic field; create an acoustic surface of a large area and any geometric shapes that produce uncommon sound effects; and obtain thin radiating surfaces of various configurations that can be used as components of furniture, the interior, decorative elements, and room design, for example, sounding ceilings, floors, walls, wallpaper, ceiling and floor covers, advertising boards and projection screens, such as, among other applications, screens for movie houses.

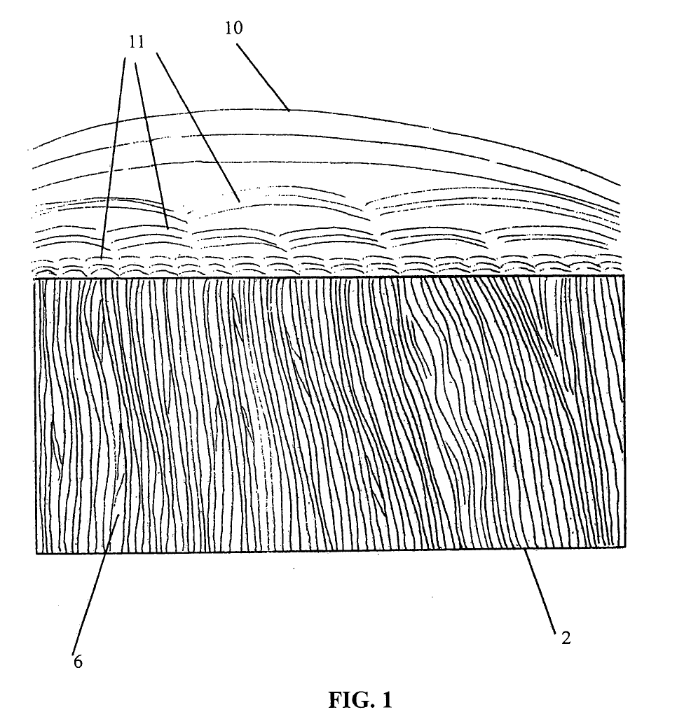

FIG. 1 illustrates a process for producing acoustic oscillations using an oscillating system that is a pre-structured gas medium.

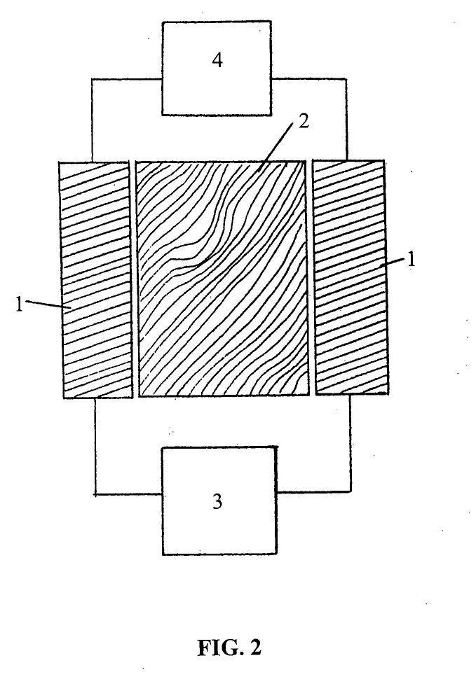

FIG. 2 is a block diagram of the transducer.

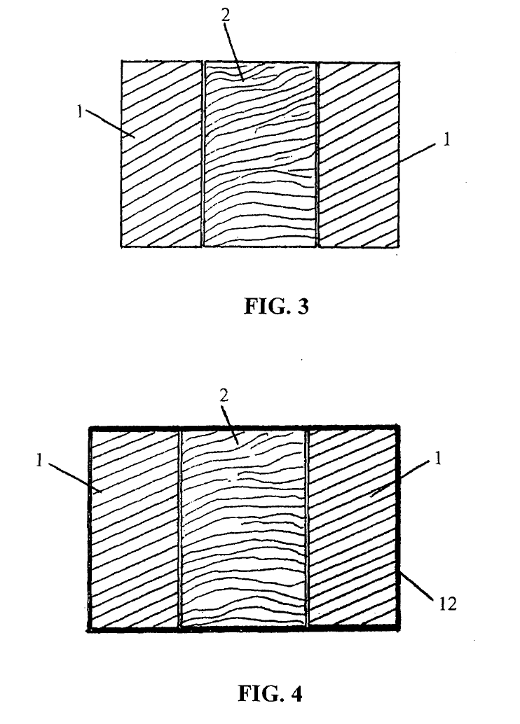

FIGS. 3, 4, 5, and 7 show variants of the aforesaid transducer design, in particular, open, enclosed (for operation in unusual conditions, such as liquid and corrosive media), symmetric, and asymmetric.

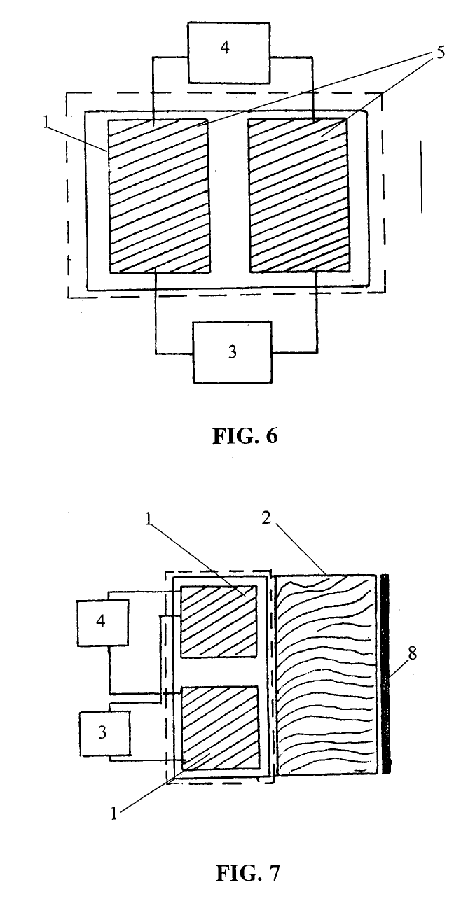

FIG. 6 shows a current-conducting plate of an asymmetrically designed transducer in the form of separated electrode regions.

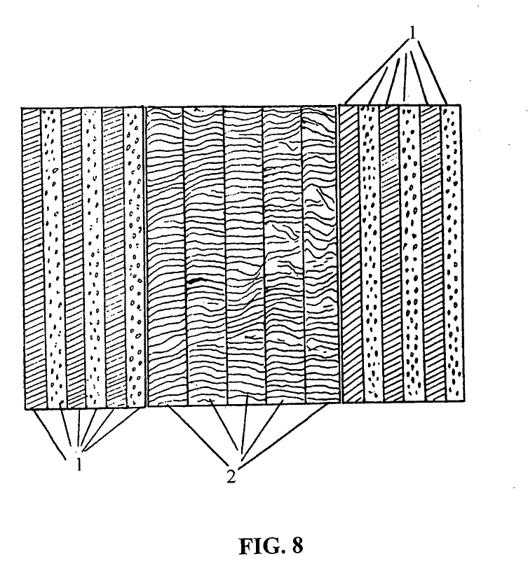

FIG. 8 illustrates a multi-layered transducer of macro-, and/or micro-, and and/or nano-level dimensions.

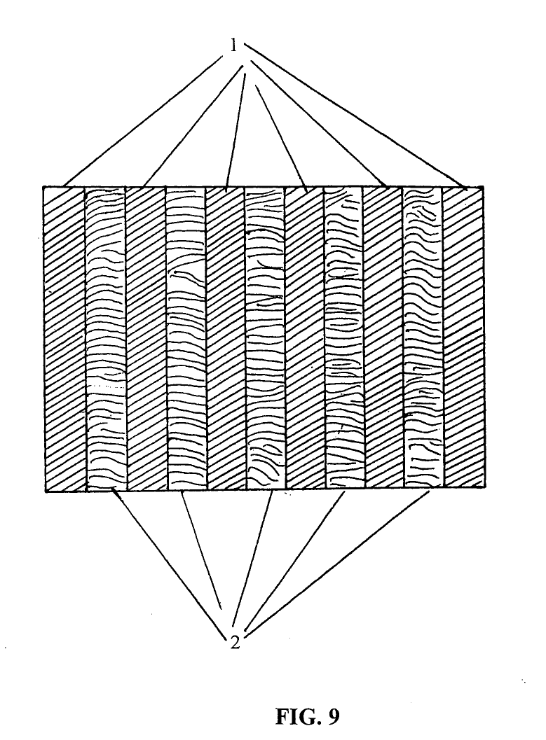

FIG. 9 illustrates a multi-layered transducer in the form of a stack consisting of alternating layers of the working element and current-conducting plates.

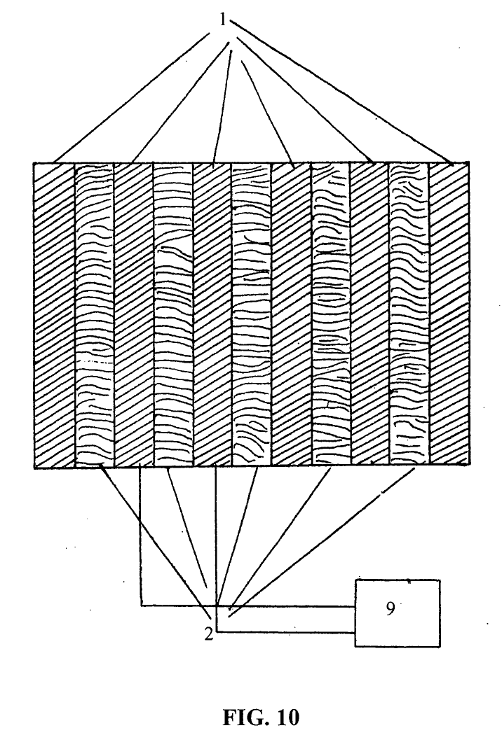

FIG. 10 illustrates a multi-layered transducer having control layers.

The transducer comprises at least two current-conducting plates 1 and a dielectric working element 2. For the transducer to become operational, the current-conducting plates are connected to the pole terminals of a direct voltage source 3 and a source 4 of alternating electric signals.

Current-conducting plates 1 may be manufactured by various methods, from various materials, and by various techniques. When current-conducting layers are deposited on substrates of different dielectric materials they may have different configurations and perforations, provided that the integrity and conductivity of the current-conducting layer are not affected; they may be gas-permeable or gas-impermeable, have different topologies and have multiple layers of macro-, and/or micro-, and/or nano-level dimensions. The electrode layer of current-conducting plates 1 may be divided to produce separate electrode regions 5. Electric connection between the layers may be effected, for example, in the form of apertures. The walls of the apertures are covered with an electrode material so that electric connection is established between the layers. The apertures may be filled with a current-conducting paste. Therefore, electric connections may extend horizontally and vertically. The current-conducting plates adhere tightly to the working element.

Working element 2 is a channeled matrix system that is produced by using specialized technological steps. As a result, a developed system of nano/micro channels 6 having a definite shape and preferred orientation is formed within the material body. The concept of matrix suggests a micro-heterogeneous dispersed phase that occupies a definite enclosed volume and is capable of absorbing another phase, and is permeable to this phase. The matrix structure predetermines the nature of transfer processes occurring therein. The properties of channeled matrixes depend to a considerable extent on their structure that, in its turn, depends on the original material and matrix manufacturing method.

The variant illustrated in FIG. 2 may be regarded as the preferred embodiment of this transducer. The transducer comprises two current-conducting plates 1 made of metal. The plates are connected to the pole terminals of direct current source 3 that can deliver voltage within the range of 10 V to 30 kV, and to a source 4 of alternating electric signals, such as any type of sound-reproducing device (player, computer, and so on). Dielectric working element 2 made of a polymer material is placed between two current-conducting plates 1.

To illustrate the operation of the transducer unambiguously, the process occurring in the working element 2 may be described as operation of a system of nano/micro electric gas-kinetic pistons/pumps (SNEGS) developing in the working element under the effect of the electric/electromagnetic field. Simultaneously, the gas medium in the matrix channels is structured. As an alternating electric signal is applied to the current-conducting plates, the in-phase operation of the SNEGS causes pulsation/oscillation of the gas medium to be produced in channels 6 of working element 2 in accordance with the shape and frequency range of the alternating electric signal. As a result, an acoustic wave 10 shown in FIG. 1 is generated over the entire surface of the transducer by in-phase addition of a plurality of individual radiations I generated by the SNEGS, the acoustic wave carrying acoustic energy. The electric signal is, therefore, converted directly into acoustic oscillations. Moreover, the developed contact surface between gas and the matrix material helps to effectively convert electric signals into acoustic oscillations with a high sensitivity, minimum distortions, and a very high front increase and decline rate.

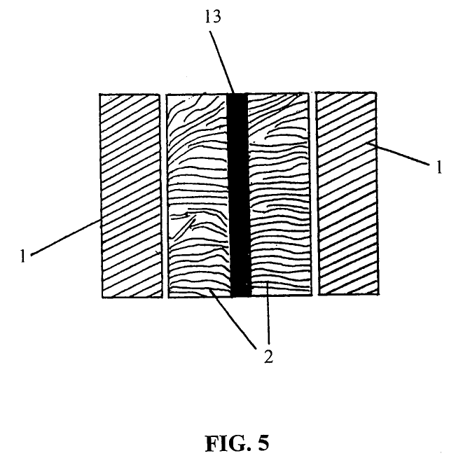

Alternatively, current-conducting plates 1 and working element 2 may be positioned in the following patterns. The resultant structure may be: symmetric (FIG. 5), in which working element 2 is divided into two parts by a gas-impermeable layer 13 and placed between current-conducting plates 1; asymmetric (FIGS. 6 and 7), in which working element 2 is placed on two current-conducting plates 1 that are separated electrode regions 5 connected to the pole terminals of direct current source 3 and source 4 of alternating electric signals, and is covered with an additional current-conducting plate 8 that overlaps the area of electrode regions 5; multi-layered of the macro-, and/or micro-, and/or nano-level dimensions (FIG. 8), in which 1—multi-layered current-conducting plates and 2—multi-layered working element; multi-layered in the form of a stack of alternating layers of the working element and current-conducting plates (FIG. 9), in which 1—current-conducting plates and 2—working element; and multi-layered with control layers (FIG. 10), in which 1—current-conducting plates, 2—working element, and 9—additional source of alternating electric signal.

The geometry of a multi-layered structure consisting of alternating layers produces an additional effect as a result of combination of the properties of individual layers making up the structure. Conversion efficiency depends on a number of parameters, in particular: thickness and number of layers making up the structure; electrical conductances of the layers; strength of mechanical connection between the layers; and surface area of the structure. The magnitude of this effect can be controlled by selecting material for the layers and geometric parameters of the structure. Combining several materials makes it possible to manufacture multi-layered structures displaying diverse properties. The choice of technique to manufacture a multi-layered structure depends on the thickness of the layers.

Moreover, the multi-functionality of the transducer suggests the possibility of free configuration options of the acoustic transducer as a whole. Acoustic transducers may be given a shape different from that of all designs known today. The transducer of this invention may be designed in the form of a panel, picture, tapestry, wallpaper, furniture, tables, or complex shapes such as vases or sculptures, and may also have any geometric shape.

Operation of such system requires electronic controls. Electronic controls may actually be manufactured by any existing methods, and will no longer be mentioned here.

Although several preferred embodiments of the invention have been described here, this invention is not confined to them alone. It is obvious that various changes and modifications can be made without departing from the idea of the invention within the scope thereof as claimed in the claims.

1. A method for converting electric signals into acoustic oscillations by exposing an oscillating system that is a gas medium pre-structured by a static electric field to an electric/electromagnetic field modulated in strength by an alternating electric signal in accordance with the shape and frequency of the modulating signal applied, and converting the energy of said field into acoustic energy that is released thereafter into the ambient.

2. An electric gas-kinetic transducer comprising a dielectric working element and at least two current-conducting plates that can be connected to the pole terminals of a direct current source and to a source of alternating electric signals, said plates comprising a single layer or multiple layers of macro-, and/or micro-, and/or nano-level dimensions, and having different topologies and relative spatial position, at least one of said plates being optionally permeable to gas and/or be designed as an electrode system, or an open pore matrix; the dielectric working element being a single- or multi-layered heterodynamic system, or “gas-capillary pore matrix,” of macro-, and/or micro-, and/or nano-level dimensions having a developed network of nano/micro gas containing channels, the layers of the system being optionally separated by a dielectric gas-impermeable layer at any point thereof and occupying a different spatial location relative to the current-conducting plates/electrode systems.

3. The transducer as claimed in claim 2, which is placed in a tightly sealed enclosed housing.

4. The transducer as claimed in claim 2, wherein the working element is placed between two current-conducting plates.

5. The transducer as claimed in claim 4, wherein the working element comprises at least two layers separated by a dielectric gas-impermeable layer.

6. The transducer as claimed in claim 2, wherein the working element is placed on two current-conducting plates that are formed as separated electrode regions that can be connected to the pole terminals of a direct current source and a source of alternating electric signals, and is covered with an additional current-conducting plate overlapping the area of the electrode regions, said additional plate being disconnected from the pole terminals of the direct current source and the source of alternating electric signals.

7. The transducer as claimed in claim 2, which comprises a plurality of layers in the form of a stack, said transducer further having at least one working element and at least one current-conducting plate, said working element and said current conducting plate alternating.

8. The transducer as claimed in claim 2, which has a plurality of layers in the form of a stack comprising alternating layers of current-conducting plates and a working element, wherein at least two current-conducting plates within the stack can be further supplied with an alternating electric signal from a separate source.

9. The transducer as claimed in claim 2, which has a plurality of layers of macro-, and/or micro-, and/or nano-level dimensions.
